(19) United States
(12) Patent Application Publication
(10) Pub. No.: US 2008/0219420 A1
(43) Pub. Date: Sep. 11, 2008

(54) Method for Billing for a Data Transmission by Selecting Accounts

(76) Inventor: Heiko Gerber, Berlin (DE)

Correspondence Address: STAAS & HALSEY LLP, SUITE 700, 1201 NEW YORK AVENUE, N.W., WASHINGTON, DC, 20005, US

(21) Appl. No.: 10/586,725

(22) PCT Filed: Oct. 26, 2004
(86) PCT No.: PCT/EP04/12241

§ 371 Date: Jul. 17, 2006

(30) Foreign Application Priority Data
Jan. 16, 2004 (EP) 04090015.1

(51) Int. Cl. H04M 15/00

(52) U.S. Cl. 379/112.01

(57) ABSTRACT

At least two billing accounts that can be accessed by a selection message of a communications terminal are used to bill for a data transmission in a telecommunication network. After the data transmission directed to the communications terminal of a communications subscriber or originating from the communications terminal has begun, a selection message of the communications terminal is received by a network element of the telecommunication network. The selection message contains an identifier of the billing account to be used for billing the data transmission. The data transmission is then billed via this billing account.

### CROSS REFERENCE TO RELATED APPLICATIONS

This application is based on and hereby claims priority to European Application No. EP 04090015 filed on Jan. 16, 2004, the contents of which are hereby incorporated by reference.

### BACKGROUND OF THE INVENTION

1. Field of the Invention

The invention relates to a method for billing for a data transmission in a telecommunication network using at least two billing accounts which can be addressed by a selection message from a communication terminal, where the method involves the data transmission sent to the communication terminal of a telecommunication subscriber or sent from the communication terminal being started.

2. Description of the Related Art

A method of this kind is known from the patent U.S. Pat. No. 6,195,419. In this method, before a telephone connection is set up, a caller requests an account number in order to bill the costs for this telephone connection using the account associated with the account number.

### SUMMARY OF THE INVENTION

The invention is based on an object of specifying a versatile method for billing for data transmissions using at least two billing accounts.

The invention achieves this object in that in a method of the abovementioned type, a network element in the telecommunication network receives the selection message from the communication terminal after the start of the data transmission, with the selection message containing an identifier for the billing account which is to be used for billing for the data transmission, and this billing account is then used to bill for the data transmission. A particular advantage in this context is that the selection message is received by the network element in the telecommunication network after the start of the data transmission. This includes receipt of the selection message while the data transmission is still in progress and also receipt of the selection message after the data transmission is terminated.

This means that the communication terminal can stipulate the billing account which is to be used for billing for the data transmission during a data transmission which is already in progress or else after the end of this data transmission. This stipulation of the billing account which is to be used can therefore advantageously be made at a time at which the communication terminal knows the nature of the data transmission and/or at least portions of the data which are to be transmitted.

The method according to the invention may be in a form such that the network element in the telecommunication network sends a selection request message to the communication terminal after the start of the data transmission, and the selection message which is then sent by the communication terminal is received by the network element in the telecommunication network. In this case, the network element uses the selection request message to prompt the communication terminal to return the selection message. This allows the telecommunication network to stipulate the time at which the communication terminal provides the identifier for the billing account using the selection message.

The inventive method may proceed in a manner such that if the selection message is not received then a predetermined billing account is used to bill for the data transmission. This advantageously allows billing for the data transmission even if the communication terminal does not send the selection message to the telecommunication network.

The method may also proceed in a manner such that the selection request message is sent to the communication terminal before the data transmission is terminated. In this case, the telecommunication network can advantageously request or retrieve the identifier for the billing account which is to be used for billing for the data transmission during a data transmission in progress.

The inventive method may proceed in a manner such that a switching node in the telecommunication network recognizes the start of the data transmission, the switching node informs a service control point in the telecommunication network about the start of the data transmission, and the service control point then prompts the sending of the selection request message to the communication terminal. This embodiment of the inventive method allows the inventive method to be carried out using switching nodes and service control points, which are often already present in telecommunication networks. This allows particularly inexpensive implementation of the inventive method.

The method may also proceed in a manner such that the selection request message is sent to the communication terminal after the data transmission is terminated. In this case, the identifier for the billing account which is to be used is advantageously requested or retrieved by the communication terminal only after the data transmission is terminated. At this time, the communication terminal advantageously has information available about the entire data transmission and the data transmitted in the process, so that this information can be used to determine the identifier.

The method may proceed in a manner such that a switching node in the telecommunication network recognizes the end of the data transmission, the switching node informs a service control point in the telecommunication network about the end of the data transmission, and the service control point then prompts the sending of the selection request message to the communication terminal. This embodiment of the method can advantageously be implemented inexpensively using switching nodes and service control points, which are already present in many telecommunication networks.

The inventive method may also proceed in a manner such that the sending of the selection request message is prompted by sending a send request message to the switching center in the telecommunication network. In the case of this embodiment of the method, the selection request message is sent by the switching center.

The inventive method may also proceed in a manner such that the selection request message is sent in the form of an Unstructured Supplementary Service Data (USSD) message, and the selection message is then received in the form of a second USSD message.

The method may alternatively proceed in manner such that the sending of the selection request message is prompted by sending a send request message to a voice output unit in the telecommunication network. In this case, the selection request message may be sent in the form of a voice and then the selection message may be received.

The inventive method may also be in a form such that the sending of the selection request message is prompted by sending a send request message to a short message service center in the telecommunication network. In this case, the selection request message may be sent in the form of a written short message, and then the selection message may be received in the form of a second written short message.

### BRIEF DESCRIPTION OF THE DRAWINGS

These and other objects and advantages of the present invention will become more apparent and more readily appreciated from the following description of the exemplary embodiments, taken in conjunction with the accompanying drawings of which:

FIG. 1 is a block diagram of a first exemplary embodiment of the inventive method with a selection message in the form of a USSD message,

FIG. 2 is a block diagram of another exemplary embodiment of the inventive method with a selection message in the form of a voice message, and

FIG. 3 is a block diagram of another exemplary embodiment of the inventive method with a selection message in the form of a written short message.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

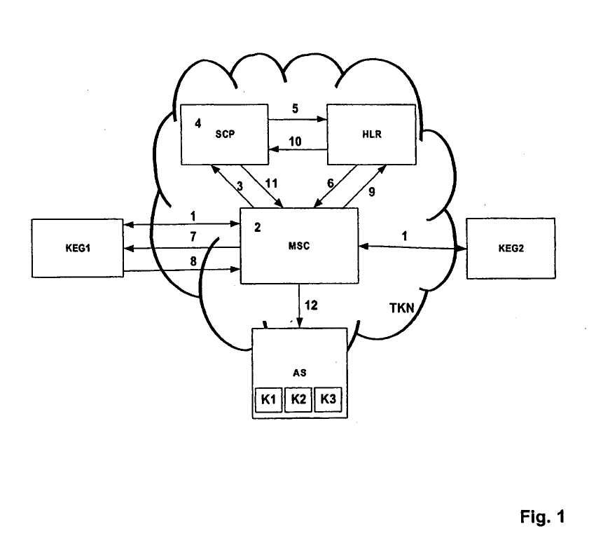

FIG. 1 shows a telecommunication network TKN which, in the exemplary embodiment, is a mobile radio network (for example a GSM or GPRS mobile radio network). In other exemplary embodiments, the telecommunication network TKN may also be other networks, however, for example landline telephone networks, in-house communication networks (Intranets) or the known Internet.

In this exemplary embodiment, the telecommunication network TKN includes a network element in the form of a switching node MSC. This switching node MSC is often produced together with a visitor location register VLR (MSC/VLR=Mobile Switching Center/Visitor Location Register). The switching node MSC (also called switching center) is connected to a home location register HLR and to a service control point SCP. In the exemplary embodiment, the telecommunication network TKN has a structure associated with an intelligent network (IN); in this case, the switching node MSC also performs the function of a service switching point SSP. In addition, the switching node MSC is connected to a billing system AS, which is a “postprocessing billing system”, for example, which is known in mobile radio networks and which can be used to bill for the costs for mobile radio links by invoicing. The billing system AS may alternatively be a “prepaid billing system”, for example, which is known as such and in which prepaid accounts associated with the individual communication terminals or their users are managed. Examples of a billing system of this kind are the systems “Charging@vantage” and “Charge@once” from Siemens AG. In the exemplary embodiment, the billing system AS includes three billing accounts K1, K2 and K3.

The switching node MSC is connected to a first communication terminal KEG1 and to a second communication terminal KEG2; in the exemplary embodiment, these two communication terminals are mobile telephones.

At the start of the method sequence shown in FIG. 1, a data transmission 1 sent by the first communication terminal KEG1 is set up to the second communication terminal KEG2 via the switching node 2 and is started. In the exemplary embodiment, this data transmission (user data transmission) is a telephone call. (In another exemplary embodiment, a data transmission in the form of a telephone call sent to the first communication terminal KEG1 could be started, likewise from the second communication terminal KEG2, at the start of the method).

The data transmission is terminated by virtue of the second communication terminal KEG2 terminating the telephone call (for example by replacing the second communication terminal's receiver or pressing an appropriate key on the second communication terminal). This termination of the data transmission is recognized by the switching node MSC in known fashion (step 2). The switching node MSC then informs the service control point SCP in the telecommunication network about the end of the data transmission by virtue of the CAP message “InitialDetectionPoint IDP” being sent from the switching node MSC to the service control point SCP (step 3). The service control point SCP checks whether the first communication terminal KEG1 (which is the caller communication terminal) is registered to participate in the method for billing for a data transmission; such registration information (subscription information) can be read from a data store in the service control point SCP, for example.

In this exemplary embodiment, it will be assumed that the first communication terminal KEG1 is registered to participate in this method. The data store in the service control point SCP likewise stores that the communication terminal KEG1 has an associated predetermined billing account in the form of the account K3. This account is then used to bill for the data transmission if no other information is available about the account which is to be used for billing. The service control point SCP then prompts a selection request message 7 to be sent to the communication terminal KEG1. This is done by virtue of the service control point SCP sending the MAP message “Unstructured Supplementary Service Request” to the home location register HLR (step 5).

The home location register HLR then sends a send request message 6 in the form of the message “Unstructured Supplementary Service Request” to the switching node MSC and thereby asks this switching node MSC to send a USSD message (USSD string) to the first communication terminal KEG1. The switching node MSC then sends a selection request message in the form of the USSD message 7 to the first communication terminal KEG1. This selection request message, i.e. this USSD string 7, is received by the first communication terminal KEG1. When this selection request message has been received, a display unit on the first communication terminal KEG1 outputs the following text: “Please select the billing account for billing for the terminated telephone call”. When a user of the first communication terminal KEG1 has pressed an appropriate key on the telephone (for example the 1 key for selecting the first billing account K1), the first communication terminal KEG1 transmits a selection message 8 (which contains an identifier “#01#” for the billing account K1 which is to be used for billing for the terminated telephone call) to the switching node MSC. The selection message is in the form of a second USSD string (USSD message).

The identifier for the billing account which is to be used for billing for the data transmission can be selected by the first communication terminal KEG1 in automated fashion too. By way of example, the first communication terminal KEG1 may store a data table in which various types of data transmissions have a respective associated identifier for a billing account. The first communication terminal KEG1 ascertains the nature of the data transmission (e.g. telephone call (voice call) or Internet session), reads the associated identifier from the table and transmits this identifier to the network element MSC in the telecommunication network using the selection message.

The selection message 8 sent by the communication terminal KEG1 is received by the switching node MSC, which forms a network element in the telecommunication network TKN. The switching node MSC in the telecommunication network TKN, which has a structure associated with an intelligent network, then transmits the information about the identifier for the billing account K1 to the home location register HLR (step 9: Return result operation UnstructuredSS-Request). The home location register HLR uses the MAP message “response MAP operation UnstructuredSS Request” to forward this information to the service control point SCP (step 10). The service control point SCP transmits the information about the received identifier to the switching node MSC using the CAP message “FurnishChargingInformation” (step 11). The switching node MSC then generates a billing information item (“ticket”) in a manner which is known per se and forwards this ticket to the postprocessing billing system AS. The transmission of this ticket to the billing system AS is also accompanied by information about the costs incurred for the mobile telephone call. The billing system AS charges the costs incurred for the mobile telephone call to the account K1 and includes these costs in the subsequent invoicing. Billing for the data transmission has therefore been effected using the billing account K1.

If, in another method sequence, the switching node MSC does not receive the selection message 8 from the first telecommunication terminal KEG1 (for example on account of a fault or because the first communication terminal KEG1 has not selected the billing account) then the network element MSC generates a ticket which is used to transmit the identifier for the predetermined billing account K3 to the billing system AS. The information about the identifier for the predetermined billing account K3 is transmitted to the switching node using the message “FurnishChargingInformation” (step 11) in this case. It is thus possible to bill for the data transmission in this case too.

In another exemplary embodiment, the operations described above may naturally also take place before the end of the data transmission, for example while a user data transmission or user data link is in progress in the form of a mobile telephone call in progress. In this case, the switching node MSC recognizes the start of the data transmission, for example (and then the switching node MSC will use a message similar to the message 3 described above to inform the service control point SCP about the start of the data transmission). The other then take place as described above. In this case, the switching node MSC writes information about an inclusive cost sum (e.g. one euro inclusive costs per telephone call), for example, into the ticket; this inclusive cost sum is then debited to the billing account determined by the identifier. Within the context of this invention, the statement “after the start of the data transmission” denotes both a time after the start and before the end of the data transmission and a time after the start and after the end of the data transmission.

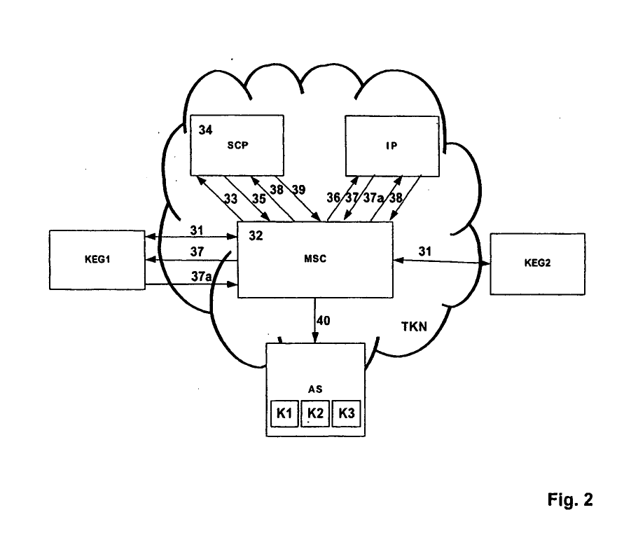

FIG. 2 shows another method sequence for the inventive method, in which steps 31 and 32 match steps 1 and 2 described in connection with FIG. 1.

The switching node MSC then sends a further CAP message 33 “InitialDetectionPoint” to the service control point SCP and thereby informs the service control point about the end of the data transmission. The service control SCP then establishes, in similar fashion to step 4 in FIG. 1, that the first communication terminal KEG1 is participating in the billing method and assigns the first communication terminal KEG1 the predetermined billing account K3 (step 34). The service control point SCP then prompts the sending of a selection request message 37 to the communication terminal KEG1 by virtue of the service control point SCP sending the CAP messages “ConnectToRessource” and “PromptAndCollectUserInformation” to the switching node MSC (step 35). The switching node MSC then sends the CAP message “PromptAndCollectUserInformation” to a voice output unit IP (Intelligent Peripheral) in the telecommunication network (step 36); this CAP message 36 is a send request message. The voice output unit IP then sends a selection request message in the form of a voice message 37 to the switching node MSC, and the switching node MSC forwards the selection request message 37 to the first communication terminal KEG1. The voice message 37 is as follows: “Please select the account for the telephone call which has just been terminated”.

When the first communication terminal KEG1 has selected the billing account K1 which is to be used for billing, the identifier for this account is transmitted to the voice output unit IP via the switching node MSC using a selection message 37a. In this case, the selection message is formed by a voice message coming from a user of the communication terminal KEG1. The voice output unit IP uses the CAP message “return result of CAP operation PromptAndCollectUserInformation” to transmit this identifier to the switching node MSC (step 38). The switching node MSC forwards this CAP message to the service control point SCP. The service control point SCP terminates the connection between the switching node MSC and the voice output unit IP using the CAP message “DisconnectForwardConnection” and forwards the identifier to the switching node MSC using the CAP message “FurnishChargingInformation” (step 39). The switching node MSC transmits the identifier together with other information relevant to the billing for the data transmission (as described in connection with FIG. 1) to the billing system AS (step 40).

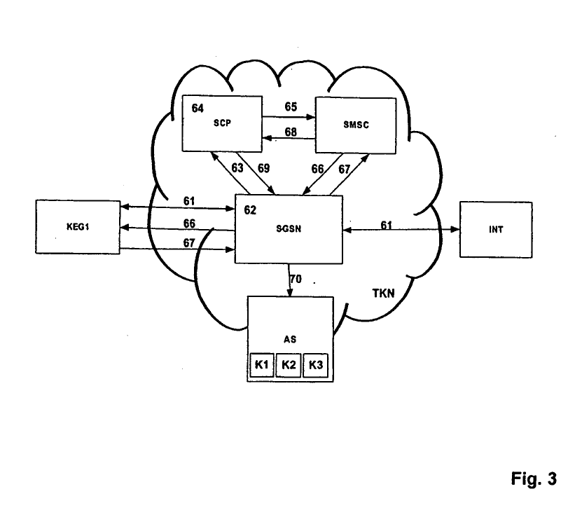

FIG. 3 shows another method for billing for a data transmission, where the data transmission is performed between the first communication terminal KEG1 in the form of a mobile telephone and a server (not shown explicitly) on the Internet INT. In this exemplary embodiment, a switching node SGSN (Servicing GPRS Support Node) forms a network element in the telecommunication network TKN. This switching node SGSN is used to start a GPRS data transmission 61 (GPRS session) between the first communication terminal KEG1 and the server on the Internet INT. When this data transmission has been terminated (e.g. disconnection of the GPRS session by the first communication terminal KEG1), the termination of the data transmission is ascertained by the switching node SGSN (step 62). The switching node SGSN then uses the CAP message “InitialDPGPRS” to inform the service control point SCP about the end of the data transmission (step 63). In step 64, the service control SCP ascertains, in known fashion, whether the first communication terminal KEG1 is participating in the method and which is the predetermined billing account (standard billing account) of the communication terminal KEG1 (account K3). The service control point SCP then prompts the sending of a selection request message 66 to the communication terminal KEG1 by sending a send request message 65 to a short message service center SMSC in the telecommunication network TKN. The short message service center SMSC then sends a selection request message in the form of a written short message 66 (SMS) to the first communication terminal KEG1 via the switching node SGSN.

The first communication terminal KEG1 then sends a selection message, in the form of a second written short message 67, containing the identifier for the billing account which is to be used for the billing to the telecommunication network TKN, and this selection message 67 is received by the network element SGSN and is forwarded to the short message service center SMSC. The selection message may be an SMS message, for example, which merely contains a character “1”. This character is the identifier for the account K1. The short message service center reads the identifier from the selection message 67 and transmits this identifier to the service control point SCP (step 68). The service control point SCP then sends information about the received identifier to the switching node SGSN using the CAP message “FurnishChargingInformationGPRS” (step 69). The switching node SGSN then transmits, in similar fashion to the switching node MSC in FIGS. 1 and 2, the received identifier to the billing system AS in ticket message 70 together with information about the costs incurred for the data transmission.

A particular advantage of the methods described is that the billing account which is to be used for billing for the data transmission can be selected during the data transmission or else after the data transmission. In particular, it is possible to allow a communication terminal in the form of a mobile telephone or landline telephone to select from a plurality of billing accounts for billing for the data transmission. The method may be in the form of an IN service in an intelligent network, which service can be booked (subscribed to) for the first communication terminal KEG1.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A method of billing for data transmission in a telecommunication network using at least two billing accounts which can be addressed by a selection message from a communication terminal, said method comprising:
starting data transmission to or from the communication terminal of a communication subscriber;
sending a selection request message from a network element in the telecommunication network to the communication terminal after said starting of the data transmission;
receiving the selection message from the communication terminal at the network element in the telecommunication network in response to said sending, the selection message containing an identifier for a billing account which is to be used for billing for the data transmission; and
using the billing account to bill for the data transmission based on the selection message received by the network element.

15. A method according to claim 14, wherein the selection request message is sent to the communication terminal before the data transmission is terminated.

16. A method according to claim 15, further comprising:
recognizing said starting of the data transmission at a switching node in the telecommunication network;
informing, by the switching node, a service control point in the telecommunication network about said starting of the data transmission; and
prompting by the service control point said sending of the selection request message to the communication terminal.

17. A method according to claim 14, wherein said sending of the selection request message to the communication terminal occurs after the data transmission is terminated.

18. A method according to claim 17, further comprising:
recognizing an end of the data transmission at a switching node in the telecommunication network;
informing, by the switching node, a service control point in the telecommunication network about the end of the data transmission; and
prompting by the service control point said sending of the selection request message to the communication terminal.

19. A method according to claim 18, wherein said prompting of the selection request message includes sending a send request message to the switching center in the telecommunication network.

20. A method according to claim 19, wherein the selection request and selection messages are Unstructured Supplementary Service Data messages.

21. A method according to claim 18, wherein said prompting of the selection request message includes sending a send request message to a voice output unit in the telecommunication network.

22. A method according to claim 21, wherein the selection request message is sent as a voice message before the selection message is received.

23. A method according to claim 18, wherein said prompting of the selection request message includes sending a send request message to a short message service center in the telecommunication network.

24. A method according to claim 23, wherein the selection request and selection messages are in a short message format.
